(19) United States
(12) Patent Application Publication
(10) Pub. No.: US 2025/0217439 A1
(43) Pub. Date: Jul. 3, 2025

(54) Number Theoretic Transform Operation Circuit

(71) Applicant: Industrial Technology Research Institute, Hsinchu (TW)

(72) Inventors: Chia-Hsiang YANG, Taipei City (TW); Liang-Hsin LIN, Yilan County (TW); Shan-Ming CHANG, Hsinchu County (TW); Yu-Ling KANG, Taoyuan City (TW); Chih-Ming LAI, Taipei City (TW)

(73) Assignee: Industrial Technology Research Institute, Hsinchu (TW)

(21) Appl. No.: 18/408,586

(22) Filed: Jan. 10, 2024

(30) Foreign Application Priority Data
Jan. 2, 2024 (TW) 113100067

(51) Int. Cl. G06F 17/15

(52) U.S. Cl. CPC G06F 17/156

(57) ABSTRACT

A number theoretic transform operation circuit includes first and second number theoretic transform units and k operation units. The first number theoretic transform unit receives 2k first coefficients in parallel and transforms an order thereof to output 2k second coefficients in parallel. k is a positive integer. The second theoretic transform unit receives 2k third coefficients in parallel and transforms an order thereof to output 2k fourth coefficients in parallel. The k operation units are coupled in parallel between the first and second number theoretic transform units and receive the 2k second coefficients to execute a polynomial operation and output the 2k third coefficients. Each k operation unit sequentially receives two of the 2k second coefficients to execute the polynomial operation and outputs two of the 2k third coefficients. Each operation unit includes a multiplier, two Boolean operation elements, two multiplexers, an adder, and a subtractor.

### CROSS-REFERENCE TO RELATED APPLICATION

This application claims the priority benefit of Taiwan application serial no. 113100067, filed on Jan. 2, 2024. The entirety of the above-mentioned patent application is hereby incorporated by reference herein and made a part of specification.

### TECHNICAL FIELD

The disclosure relates to an operation circuit, and in particular to a number theoretic transform operation circuit used in lattice-based cryptography.

### BACKGROUND

With the rapid development of quantum computers, contemporary cryptography systems such as Elliptic Curve Cryptography (ECC) and RSA encryption algorithm are exposed to the threat of quantum computers. Therefore, the National Institute of Standards and Technology (NIST) launched the Post Quantum Cryptography project in 2017, launching a series of cryptographic algorithm selections and striving to formulate cryptographic standards in the new era to defend from quantum computer attacks. In today's post-quantum cryptography standards, most algorithms including Dilithium and FALCON are based on the mathematical structure of lattice-based cryptography.

Moreover, with the rise of artificial intelligence, homomorphic encryption has become one implementation method of privacy-preserving machine learning (PPML), allowing model owners and data owners to perform joint AI operations such as model inference under the premise of not disclosing information from both parties, thus implementing services such as Prediction-as-a-Service (PaaS), and the homomorphic encryption algorithm CKKS widely used today is also formulated based on the mathematical architecture of lattice cryptography.

However, most quantum cryptography adopts a customized number theoretic transform architecture, which is designed for a single modulus, thus needing more clock cycles and a lower degree of parallelism. Moreover, some quantum cryptography adopts a customized number theoretic transform architecture, which also refers to using very few operation units to reduce the area of the hardware. The disadvantage is that the degree of parallelization thereof is lower, the clock cycle of the operation is longer, and the frequency is also lower.

Moreover, a conventional number theoretic transform architecture also uses multiple sets of operation units, but each of the operation units contains a plurality of multipliers to support Montgomery modular multiplication. Therefore, the hardware resource consumption of each of the operation units is higher, and the difficulty to expand the operation unit to support operation is also greater. Furthermore, such number theoretic transform architecture adopts a large number of modular operations in the operation process, wherein a large number of comparison operations are needed.

Therefore, how to reduce the number of elements in the operation units in the number theoretic transform architecture, and by analyzing the input and output range values, to eliminate comparison operations, reduce the complexity of operations, reduce hardware resource consumption, and reduce the clock cycle of operations is an issue that need to be solved urgently.

### SUMMARY

The disclosure provides a number theoretic transform operation circuit including a first number theoretic transform unit, a second number theoretic transform unit, and k operation units. The first number theoretic transform unit is configured to receive 2k first coefficients in parallel and transform an order of the 2k first coefficients to output 2k second coefficients in parallel, wherein k is a positive integer. The second theoretic transform unit is configured to receive 2k third coefficients in parallel and transform an order of the 2k third coefficients to output 2k fourth coefficients in parallel. The k operation units are coupled in parallel between the first number theoretic transform unit and the second number theoretic transform unit and configured to receive the 2k second coefficients to execute a polynomial operation and output the 2k third coefficients. Each of the k operation units sequentially receives two of the 2k second coefficients to execute the polynomial operation and output two of the 2k third coefficients. Each of the operation units includes a multiplier, two Boolean operation elements, two multiplexers, an adder, and a subtractor.

Based on the above, the number theoretic transform operation circuit provided by the disclosure may support the polynomial operations needed in lattice cryptography, achieving better hardware performance, lower hardware resource consumption, and lower operation clock cycles than prior art. At the same time, the number theoretic transform operation circuit provided by the disclosure has features of reconfiguration and easy expansion, and may support other types of polynomial operations in lattice cryptography and reduce the complexity of operations.

### BRIEF DESCRIPTION OF THE DRAWINGS

FIG. 1 is an architectural diagram of a number theoretic transform operation circuit shown according to an embodiment of the disclosure.

FIG. 2 is an architectural diagram of an operation unit in a number theoretic transform operation circuit shown according to an embodiment of the disclosure.

### DETAILED DESCRIPTION OF DISCLOSED EMBODIMENTS

A portion of the exemplary embodiments of the disclosure is described in detail hereinafter with reference to figures. In the following, the same reference numerals in different figures should be considered to represent the same or similar elements. The exemplary embodiments are a part of the disclosure, and do not disclose all possible implementation modes of the disclosure. Rather, these exemplary embodiments are merely examples of methods, devices, and systems within the scope of the patent application of the disclosure.

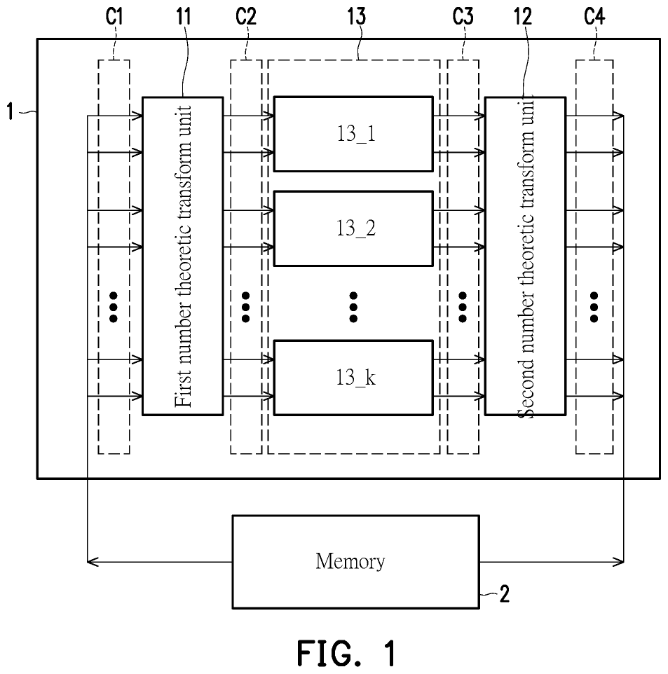

FIG. 1 is an architectural diagram of a number theoretic transform operation circuit 1 shown according to an embodiment of the disclosure. Referring to FIG. 1, the number theoretic transform operation circuit 1 includes a first number theoretic transform unit 11, a second number theoretic transform unit 12, and k operation units 13.

In terms of hardware architecture, the k operation units 13 are coupled in parallel between the first number theoretic transform unit 11 and the second number theoretic transform unit 12.

Overall, the input of the number theoretic transform operation circuit 1 is 2k first coefficients C1. The 2k first coefficients C1 include two different polynomial coefficients, that is, half of the 2k first coefficients C1 are coefficients of a first polynomial, the other half of the 2k first coefficients C1 are coefficients of a second polynomial, and each of the polynomials has k coefficients represented by m bits. Moreover, the output of the number theoretic transform operation circuit 1 is 2k fourth coefficients C4. The 2k fourth coefficients C4 also include two different polynomial coefficients. That is, half of the 2k fourth coefficients C4 are used as coefficients of a third polynomial, and the other half of the 2k fourth coefficients C4 are used as coefficients of a fourth polynomial, and each of the polynomials has k coefficients expressed by m bits.

The first number theoretic transform unit 11 and the second number theoretic transform unit 12 are both exchange structures. The first number theoretic transform unit 11 is configured to receive the 2k first coefficients C1 in parallel and transform an order of the 2k first coefficients C1 to output 2k second coefficients C2 in parallel, wherein k is a positive integer. The second theoretic transform unit 12 is configured to receive 2k third coefficients C3 in parallel and transform an order of the 2k third coefficients C3 to output 2k fourth coefficients C4 in parallel. In an embodiment, the first number theoretic transform unit 11 receives the 2k first coefficients C1 from the memory 2 in parallel, and the second number theoretic transform unit 12 outputs the 2k fourth coefficients C4 to the memory 2.

In addition, the k operation units 13 receive the 2k second coefficients C2 to execute a polynomial operation and output the 2k third coefficients C3. In detail, each of the k operation units 13 sequentially receives two of the 2k second coefficients C2 to execute a polynomial operation and outputs two of the 2k third coefficients C3. That is, the operation unit 13_1 receives the 1st to 2nd second coefficients C2 to execute a polynomial operation and outputs the 1st to 2nd third coefficients C3, and the operation unit 13_2 receives the 3rd to 4th second coefficient C2 to execute a polynomial operation and outputs the 3rd to 4th third coefficients C3. By analogy, the operation unit 13_k receives the (k−1)th to k-th second coefficient C2 to execute a polynomial operation and outputs the (k−1)th to k-th third coefficients C3.

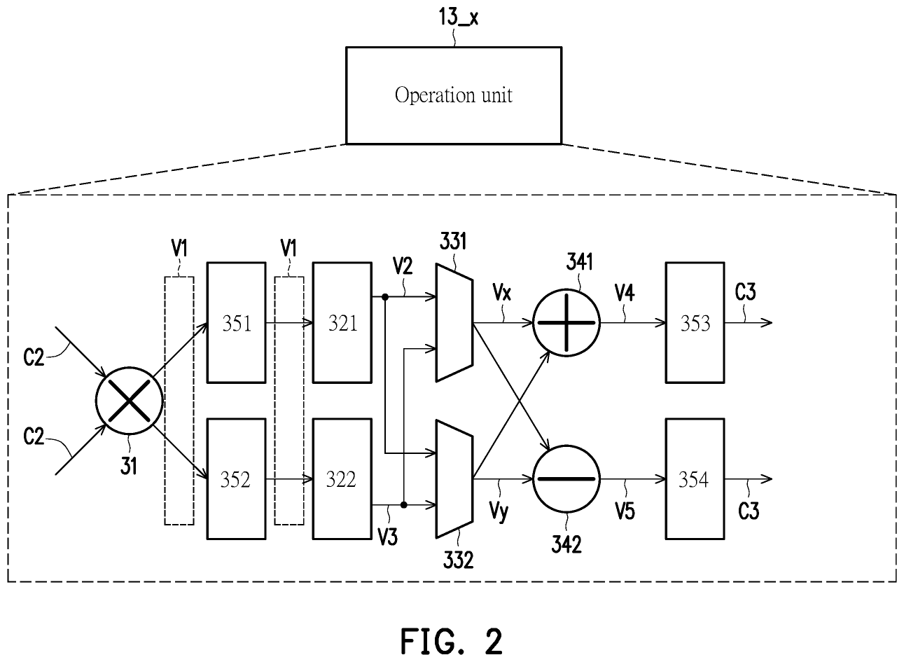

FIG. 2 is an architectural diagram of an operation unit 13_x in the number theoretic transform operation circuit 1 shown according to an embodiment of the disclosure. Please refer to FIG. 1 and FIG. 2 at the same time. The operation unit 13_x is one of the k operation units 13 in FIG. 1. Each of the k operation units 13 includes a multiplier, two Boolean operation elements, two multiplexers, an adder, and a subtractor. Since the architecture of each of the k operation units 13 is the same, a single operation unit 13_x is further described next.

The operation unit 13_x includes a multiplier 31, a Boolean operation element 321, a Boolean operation element 322, a multiplexer 331, a multiplexer 332, an adder 341, and a subtractor 342. In an embodiment, the number of each of the multiplier 31, the adder 341, and the subtractor 342 included in the operation unit 13_x in the number theoretic transform operation circuit 1 is one.

The multiplier 31 is coupled to the first number theoretic transform unit 11 and configured to receive two of the 2k second coefficients C2 and execute a multiplication operation to output a first value V1. As described above, the two second coefficients C2 received by the multiplier 31 are the two second coefficients C2 received sequentially by the operation unit 13_x. Assuming that the operation unit 13_x is the operation unit 13_2, the two second coefficients C2 received by the multiplier 31 are the 3rd to 4th second coefficients C2.

The Boolean operation elements 321 and 322 are coupled in parallel to the multiplier 31 and configured to receive the first value V1 and execute a bit shift operation to respectively output a second value V2 and a third value V3.

Each of the multiplexers 331 and 332 has two input terminals, and each of the input terminals is coupled to the Boolean operation elements 321 and 322 respectively and configured to receive the second value V2 and the third value V3, and selects to output the second value V2 or the third value V3 respectively. Since the multiplexer 331 may output the second value V2 or output the third value V3, the multiplexer 331 is represented by a multiplexer output value Vx in FIG. 2. Similarly, since the multiplexer 332 may also output the second value V2 or output the third value V3, the multiplexer 331 is represented by a multiplexer output value Vy in FIG. 2.

The adder 341 is coupled to each of the multiplexers 331 and 332 and configured to receive the second value V2 or the third value V3 output by each of the two multiplexers 331 and 332 and execute an addition operation to output a fourth value V4. The subtractor 342 is coupled to each of the two multiplexers 331 and 332 and configured to receive the second value V2 or the third value V3 output by each of the two multiplexers 331 and 332 and execute a subtraction operation to output a fifth value V5.

The second number theoretic transform unit 12 receives 2k third coefficients C3 sequentially composed of the fourth value V4 output by the adder 341 and the fifth value V5 output by the subtractor 342 of each of the k operation units 13_1, 13_2 . . . 13_k.

Specifically, the fourth value V4 and the fifth value V5 output by the operation unit 13_1 are the first to second third coefficients C3 received by the second number theoretic transform unit 12, and the fourth value V4 and the fifth value V5 output by the operation unit 13_2 are the third to fourth third coefficients C3 received by the second number theoretic transform unit 12. By analogy, the fourth value V4 and the fifth value V5 output by the operation unit 13_x are the (2x−1)th to 2x-th third coefficients C3 received by the second number theoretic transform unit 12, and the fourth value V4 and the fifth value V5 output by the operation unit 13_k are the (2k−1)th to 2k-th third coefficients C3 received by the second number theoretic transform unit 12.

In an embodiment, each of the operation units 13 further includes four registers; wherein two registers 351 and 352 in the four registers are respectively coupled between the multiplier 31 and each of the two Boolean operation elements 321 and 322 and configured to buffer the first value V1 output by the multiplier 31 and input the first value V1 to each of the two Boolean operation elements 321 and 322; wherein the other two registers 353 and 354 of the four registers are respectively coupled between the adder 341 and the second number theoretic transform unit 12 and coupled between the subtractor 342 and the second number theoretic transform unit 12 and configured to buffer the fourth value V4 output by the adder 341 and the fifth value V5 output by the subtractor 342, and input the fourth value V4 and the fifth value V5 to the second number theoretic transform unit 12.

The polynomial operation executed by each of the k operation units 13 includes at least one of a number theoretic transform operation, a polynomial addition operation, a polynomial subtraction operation, a polynomial point-to-point modular multiplication operation, and a butterfly operation. Each polynomial operation may be broken down into several rounds to complete. In each round, the number theoretic transform operation circuit 1 completes k polynomial operations of the same type via the k operation units 13.

Specifically, in each round, the number theoretic transform operation circuit 1 rearranges the 2k first coefficients C1 via the first number theoretic transform unit 11 to generate the 2k second coefficients C2, then completes k polynomial operations of the same type via the k operation units 13 to generate the 2k third coefficients C3, and then rearranges via the second number theoretic transform unit 12, and lastly obtains the 2k fourth coefficients C4 as output. Via the pipeline method, each round needs an average of 1 clock cycle.

In an embodiment, the number of terms of the first polynomial is N, and in response to the polynomial operation being the polynomial addition operation or the polynomial subtraction operation, since the number theoretic transform operation circuit 1 completes k polynomial addition operations or polynomial subtraction operations via the k operation units 13 in each round, the polynomial addition operations or the polynomial subtraction operations may be broken down into N/k rounds, wherein N is an integer multiple of k. Therefore, it takes N/k clock cycles on average for the number theoretic transform operation circuit 1 to execute the polynomial addition operation or the polynomial subtraction operation.

In an embodiment, the number of terms of the first polynomial is N, and in response to the polynomial operation being the polynomial point-to-point modular multiplication operation, since the number theoretic transform operation circuit 1 completes k polynomial point-to-point modular multiplication operations via the k operation units 13 in two rounds, the polynomial point-to-point modular multiplication operation may be broken down into 2N/k rounds, wherein N is an integer multiple of k. Therefore, it takes 2N/k clock cycles on average for the number theoretic transform operation circuit 1 to execute the polynomial point-to-point modular multiplication operation.

Next, the details of how the number theoretic transform operation circuit 1 completes k polynomial point-to-point modular multiplication operations via the k operation units 13 in two rounds are described. Please refer to Table 1.

TABLE 1
Modular multiplication (ModMul)

| Parameter | R = 2^{l}^{₁}, p = 2^{l}^{₁} − 2^{l}^{₂} + 1 < R, p⁻¹ = 2^{l}^{₂} + 1 mod R | |
|---|---|---|
| Input | $a ∈ [ - \frac{{B}_{M} p}{2} , \frac{{B}_{M} p}{2} ] ,$ | $b ∈ [ - \frac{p}{2} , \frac{p}{2} ]$ |
| Output | $c ∈ [ - \frac{{B}_{M}^{′} p}{2} , \frac{{B}_{M}^{′} p}{2} ]$ | |
| Round 1 | t = a × b | Eq (1.1) |
| | t₁ = t >> l₁ | Eq (1.2) |
| | t₂ = (t mod R) << l₂ | Eq (1.3) |
| | t₃ = (t mod R) | Eq (1.4) |
| | t₀ = [(t mod R) × p⁻¹] mod R = | Eq (1.5) |
| | (t₂ + t₃) mod R | |
| Round 2 | t₄ = t₀ × p | Eq (1.6) |
| | t₅ = t₄ >> l₁ | Eq (1.7) |
| | c = t₁ − t₅ | Eq (1.8) |

Corresponding to the hardware architecture in the operation units 13, in round 1, the equation Eq(1.1) is executed first via the multiplier 31, then the equations Eq(1.2), Eq(1.3), and Eq(1.4) are executed via the Boolean operation elements 321 and 322, and lastly the equation Eq(1.5) is calculated via the adder 341. In round 2, equation Eq(1.6) is executed first via the multiplier 31, then equation Eq(1.7) is executed via the Boolean operation elements 321 and 322, and lastly equation Eq(1.8) is calculated via the subtractor 342.

The input numerical range and output numerical range of modular multiplication have the following relationship:

$$\vert c \vert \leq \frac{\frac{{B}_{M} p}{2 R} \times \frac{p}{2}}{R} + \frac{\frac{p}{2} \times p}{R} = ( \frac{{B}_{M}}{2} + 1 ) \frac{p}{R} \frac{p}{2} \leq ( \frac{{B}_{M}}{2} + 1 ) ( \frac{p}{2} ) ⇒ {B}_{M}^{′} = \frac{{B}_{M}}{2} + 1 \qquad Prop ( 1 )$$

In an embodiment, the number of terms of the first polynomial is N, and in response to the polynomial operation being a butterfly operation, since the number theoretic transform operation circuit 1 completes k butterfly operations via the k operation units 13 in three rounds, the butterfly operation may be broken down into (3Nlog₂N)/2k rounds, wherein N is an integer multiple of k. Therefore, it takes (3Nlog₂N)/2k clock cycles on average for the number theoretic transform operation circuit 1 to execute the butterfly operation.

Number Theoretic Transform (NTT) and the inverse operation (Inverse Number Theoretic Transform, INTT) thereof adopt different butterfly operations. The butterfly operation in NTT is Cooley-Tukey Butterfly, which may be implemented by the following steps. Please refer to Table 2.

TABLE 2
Cooley-Tukey Butterfly

| | | | |
|---|---|---|---|
| Input | $a ∈ [ - \frac{{B}_{C}^{i} p}{2} , \frac{{B}_{C}^{i} p}{2} ] ,$ | $b ∈ [ - \frac{{B}_{C}^{i} p}{2} , \frac{{B}_{C}^{i} p}{2} ] ,$ | $ω ∈ [ - \frac{R}{2} , \frac{R}{2} ]$ |

| | | |
|---|---|---|
| Output | $c ∈ [ - \frac{{B}_{C}^{i + 1} p}{2} , \frac{{B}_{C}^{i + 1} p}{2} ] ,$ | $d ∈ [ - \frac{{B}_{C}^{i + 1} p}{2} , \frac{{B}_{C}^{i + 1} p}{2} ]$ |

| Rounds | t = ModMul(b, ω) | Eq (2.1) |
|---|---|---|
| 1 to 2 | | |
| Round 3 | (c, d) = (a + t, a − t) | Eq (2.2) |

Corresponding to the hardware architecture in the operation units 13, in round 1 and round 2, equation Eq(2.1) is executed via the modular multiplication operation (ModMul). In round 3, equation Eq(2.2) is calculated via the adder 341 and the subtractor 342.

The input numerical range and output numerical range of the butterfly operation (Cooley-Tukey Butterfly) have the following relationship:

$$\vert c \vert \leq \frac{{B}_{C}^{i} p}{2} + ModMul ( b , ω ) \leq \frac{{B}_{C}^{i} p}{2} + ( \frac{{B}_{C}^{i}}{2} + 1 ) \frac{p}{2} = ( \frac{3 {B}_{C}^{i}}{2} + 1 ) \frac{p}{2} \qquad Prop ( 2 )$$

$$\vert d \vert \leq \frac{{B}_{C}^{i} p}{2} + ModMul ( b , ω ) = ( \frac{3 {B}_{C}^{i}}{2} + 1 ) \frac{p}{2} ⇒ {B}_{C}^{i + 1} = \frac{3 {B}_{C}^{i}}{2} + 1$$

The butterfly operation in INTT is Gentleman-Sande Butterfly, which may be implemented by the following steps. Please refer to Table 3.

TABLE 3
Gentleman-Sande Butterfly

| | | | |
|---|---|---|---|
| Input | $a ∈ [ - \frac{{B}_{G}^{i} p}{2} , \frac{{B}_{G}^{i} p}{2} ] ,$ | $b ∈ [ - \frac{{B}_{G}^{i} p}{2} , \frac{{B}_{G}^{i} p}{2} ] ,$ | $ω ∈ [ - \frac{R}{2} , \frac{R}{2} ]$ |

| | | |
|---|---|---|
| Output | $c ∈ [ - \frac{{B}_{G}^{i + 1} p}{2} , \frac{{B}_{G}^{i + 1} p}{2} ] ,$ | $d ∈ [ - \frac{{B}_{G}^{i + 1} p}{2} , \frac{{B}_{G}^{i + 1} p}{2} ]$ |

| | | |
|---|---|---|
| Round 1 | (c, t) = (a + b, a − b) | Eq (3.1) |
| Round 3 | t = ModMul(t, ω) | Eq (2.2) |

Corresponding to the hardware architecture in the operation units 13, in round 1, equation Eq(3.1) is calculated via the adder 341 and the subtractor 342. In round 3, the equation Eq(3.2) in the modular multiplication operation (ModMul) is used.

The input numerical range and output numerical range of the butterfly operation (Gentleman-Sande Butterfly) have the following relationship:

$$\vert c \vert \leq 2 ( \frac{{B}_{G}^{i} p}{2} ) = 2 {B}_{G}^{i} ( \frac{p}{2} ) \qquad Prop ( 3 )$$

$$\vert d \vert \leq ModMul ( t , ω ) \leq ( \frac{2 {B}_{G}^{i}}{2} + 1 ) \frac{p}{2} = ( by Prop ( 1 ) ) = ( {B}_{G}^{i} + 1 ) \frac{p}{2} ⇒ {B}_{G}^{i + 1} = max [ 2 {B}_{G}^{i} , {B}_{G + 1}^{i} ] = 2 {B}_{G}^{i}$$

According to Prop(2) and Prop(3), when a plurality of butterfly operations are performed continuously, the range of the coefficients grow by up to twice. Therefore, during the number theoretic transform process, it is necessary to ensure that the coefficients do not exceed the m-bit representation range. Since the butterfly operation of the log₂N level is performed during the number theoretic transform process, assuming B_{C}⁰=B_{G}⁰=1, the following formula needs to be established:

$$Prop ( 4 )$$

$$( {B}_{C}^{{log}_{2} N} ) \frac{p}{2} \leq ( {B}_{G}^{{log}_{2} N} ) \frac{p}{2} = ( {2}^{{log}_{2} N} ) \frac{p}{2} = \frac{Np}{2} \leq {2}^{m} ⇒ m \geq {log}_{2} ( Np ) - 1$$

As mentioned above, each of the operation units 13 includes one multiplier 31, one adder 341, one subtractor 342, and two Boolean operation elements 321 and 322 to support number theoretic transform, polynomial addition (subtraction), and polynomial point-to-point modular multiplication. If other polynomial operations are to be supported, the functions of the Boolean operation elements may be expanded (such as adding a comparator), or the data process supported by the operation units 13 may be added (such as adding an operation of an addition followed by a subtraction, and the subtraction is followed by a displacement) to support other polynomial operations.

Based on the above, the number theoretic transform operation circuit provided by the disclosure may support the polynomial operations needed in lattice cryptography, achieving better hardware performance, lower hardware resource consumption, and lower operation clock cycles than prior art. At the same time, the number theoretic transform operation circuit provided by the disclosure has features of reconfiguration and easy expansion, and may support other types of polynomial operations in lattice cryptography and reduce the complexity of operations.

What is claimed is:

1. A number theoretic transform operation circuit, comprising:
a first number theoretic transform unit configured to receive 2k first coefficients in parallel and transform an order of the 2k first coefficients to output 2k second coefficients in parallel, wherein k is a positive integer;
a second theoretic transform unit configured to receive 2k third coefficients in parallel and transform an order of the 2k third coefficients to output 2k fourth coefficients in parallel; and
k operation units, wherein the k operation units are coupled in parallel between the first number theoretic transform unit and the second number theoretic transform unit and configured to receive the 2k second coefficients and execute a polynomial operation to output the 2k third coefficients;
wherein each of the k operation units sequentially receives two of the 2k second coefficients and executes the polynomial operation to output two of the 2k third coefficients;
wherein each of the k operation units comprises a multiplier, two Boolean operation elements, two multiplexers, an adder, and a subtractor.

2. The number theoretic transform operation circuit of claim 1, wherein
the multiplier is coupled to the first number theoretic transform unit and configured to receive the two of the 2k second coefficients and execute a multiplication operation to output a first value;
the two Boolean operation elements are coupled in parallel to the multiplier and configured to receive the first value and execute a bit shift operation to respectively output a second value and a third value;
each of the two multiplexers is coupled to each of the Boolean operation elements and configured to receive the second value and the third value, and selects to output the second value or the third value respectively;
the adder is coupled to each of the two multiplexers and configured to receive the second value or the third value output by each of the two multiplexers and execute an addition operation to output a fourth value; and
the subtractor is coupled to each of the two multiplexers and configured to receive the second value or the third value output by each of the two multiplexers and execute a subtraction operation to output a fifth value.

3. The number theoretic transform operation circuit of claim 2, wherein the second number theoretic transform unit receives the 2k third coefficients sequentially composed of the fourth value output by the adder and the fifth value output by the subtractor in each of the k operation units.

4. The number theoretic transform operation circuit of claim 1, wherein half of the 2k first coefficients are coefficients of a first polynomial, and the other half of the 2k first coefficients are coefficients of a second polynomial;
wherein half of the 2k fourth coefficients are used as coefficients of a third polynomial, and the other half of the 2k fourth coefficients are used as coefficients of a fourth polynomial.

5. The number theoretic transform operation circuit of claim 4, wherein the polynomial operation comprises at least one of a number theoretic transform operation, a polynomial addition operation, a polynomial subtraction operation, a polynomial point-to-point modular multiplication operation, and a butterfly operation.

6. The number theoretic transform operation circuit of claim 5, wherein a number of terms of the first polynomial is N, and in response to the polynomial operation being the polynomial addition operation or the polynomial subtraction operation, the k operation units execute N/k rounds of the polynomial operation, wherein N is an integer multiple of k.

7. The number theoretic transform operation circuit of claim 5, wherein a number of terms of the first polynomial is N, and in response to the polynomial operation being the polynomial point-to-point modulo multiplication, the k operation units execute 2N/k rounds of the polynomial operation, wherein N is an integer multiple of k.

8. The number theoretic transform operation circuit of claim 5, wherein a number of terms of the first polynomial is N, and in response to the polynomial operation being the butterfly operation, the k operation units execute
$$\frac{3 N {log}_{2} N}{2 k}$$
rounds of the polynomial operation, wherein N is an integer multiple of k.

9. The number theoretic transform operation circuit of claim 2, wherein each of the operation units further comprises four registers;
wherein two of the four registers are respectively coupled between the multiplier and each of the two Boolean operation elements and configured to buffer the first value output by the multiplier and input the first value into each of the two Boolean operation elements;
wherein the other two of the four registers are respectively coupled between the adder and the second number theoretic transform unit and coupled between the subtractor and the second number theoretic transform unit and configured to buffer the fourth value output by the adder and buffer the fifth value output by the subtractor, and input the fourth value and the fifth value to the second number theoretic transform unit.

10. The number theoretic transform operation circuit of claim 1, wherein the first number theoretic transform unit receives the 2k first coefficients from a memory in parallel, and the second number theoretic transform unit outputs the 2k fourth coefficients to the memory.
